(19) United States
(12) Patent Application Publication
(10) Pub. No.: US 2006/0165920 A1
(43) Pub. Date: Jul. 27, 2006

(54) Image recording sheet and method of image recording

(76) Inventor: Hideki Nakanishi, Osaka (JP)

Correspondence Address: BIRCH STEWART KOLASCH & BIRCH, PO BOX 747, FALLS CHURCH, VA, 22040-0747, US

(21) Appl. No.: 10/544,395

(22) PCT Filed: Feb. 2, 2004
(86) PCT No.: PCT/JP04/01019

§ 371 Date: Aug. 3, 2005

(30) Foreign Application Priority Data
Feb. 5, 2003 (JP) 2003-28369
Feb. 10, 2003 (JP) 2003-32497
May 7, 2003 (JP) 2003-128737

(51) Int. Cl. B41M 5/00

(52) U.S. Cl. 428/32.1

(57) ABSTRACT

A receptive layer of an image-recording sheet comprises a polysaccharide or a derivative thereof (e.g., a cellulose derivative such as a hydroxyalkyl cellulose) as a film-formable resin component, and an aliphatic dye fixing agent (e.g., an aliphatic quaternary ammonium salt such as a trimethyC₈₋₁₆alkylammonium halide). The film-formable resin component may contain an oxyalkylene-series polymer (e.g., a polyethylene glycol). The image-recording sheet is suitable for a image-forming method utilizing a thermal action on the receptive layer. The receptive layer may be either non-transferable or transferable. The transferable image-recording sheet comprises a substrate and a transfer layer, and the transfer layer is formed on and separable from the substrate and contains at least a receptive layer. The transfer layer may be transferable to an object. The receptive layer may contain a hot-melt adhesive resin particle. Such an image-recording sheet or a method for forming an image ensures high color quality and color density, and can prevent the generation of a harmful substance even by heating.

### TECHNICAL FIELD

The present invention relates to an image-recording sheet on which a recording image is formable by e.g., an ink-jet printer, and which inhibits generation of a harmful substance by heating, an image-forming method or an image-transfer method using the image-recording sheet, and a method for inhibiting the generation of the harmful substance by heating.

### BACKGROUND ART

The thermal recording systems, especially an ink-jet recording system and a sublimation dye transfer recording system are easily applicable to full-color image production, and are excellent in printing quality, so that the systems are used for image recording. These recording systems require a high color density on an image-recording sheet. On the other hand, it is known a transfer recording system which comprises forming an image on a receptive layer of an image-recording sheet by utilizing the above-mentioned recording system (in particular, the ink-jet recording system), contacting the image-formed receptive layer with an object under heat, and transferring the image to the object together with the receptive layer. Such a system is utilized, for example, for print of the object such as a fabric (e.g., a T-shirt). In the transfer recording system, the receptive layer of the image-recording sheet requires not only thermal transferability and adhesiveness to the object but also absorbency on an ink, dye fixing property and others. In addition, the receptive layer requires high water resistance and washing resistance in the case of forming the transferring image on the object such as clothing.

Japanese Patent Application Laid-Open No. 232936/2001 (JP-2001-232936A) discloses a transfer sheet for an ink-jet printer, wherein the sheet comprises a transfer layer separable from a substrate, and the transfer layer has an oil absorption of not less than 50 ml/100 g, and includes a first hot-melt adhesive resin particle being porous. The literature describes that the transfer layer may contain a second hot-melt adhesive resin particle with an oil absorption of less than 50 ml/100 g, a film-formable resin component such as a hydrophilic polymer (e.g., a polyethylene glycol, an acrylic polymer, a vinyl ether-series polymer, and a cellulose derivative), and a dye fixing agent. Further, the literature describes as the dye fixing agent, a cationic compound (e.g., an aliphatic ammonium salt and an aromatic ammonium salt) and a polymeric dye fixing agent. The transfer sheet of this literature comprises the first porous hot-melt adhesive resin particle, and has high ink-absorbency, so that the sheet prevents an un-dried ink from transferring to an image-formed area due to a feeding roller when the image is formed on the transfer layer by an ink-jet printer. That is, the sheet prevents the un-dried ink from indented transferring (stain transfer). However, it is difficult to improve color quality, in particular color density, as long as the transfer layer of the sheet is used. Therefore, clearness of the image or quality of the full color image cannot be improved. Furthermore, the supplementary examination for the Examples described in the literature found out that the possibility to generate a harmful substance (e.g., benzyl chloride) pointed out as a causative agent for carcinogenicity during the thermal transfer. This means that the working environment is made worse, and in addition, safety dose not sufficiently satisfied.

It is therefore an object of the present invention to provide an image-recording sheet which has high color quality and color density, and prevents generating a harmful substance even by heating, and in addition to provide a method for forming an image using the sheet.

It is another object of the present invention to provide an image-recording sheet which is capable of not only improving color density of an image but also having high ink-absorbency and forming a clear image while inhibiting stain transfer, and a method for forming an image by using the sheet.

It is still another object of the present invention to provide an image-recording sheet comprising a receptive layer which is excellent in both thermal transferability and adhesiveness to an object without deteriorating a working environment or a safety, even when the image-recording sheet is applied to a recording system utilizing a thermal action (e.g., a thermal recording by sublimation dye transfer to a receptive layer, or a thermal-transfer recording of an image-formed receptive layer), and to provide a method to form an image using the sheet.

It is another object of the present invention to provide a method which can improve color density of the image, prevent generation of a harmful substance by heating, and improve the working environment and the safety.

### DISCLOSURE OF THE INVENTION

The inventor of the present invention made intensive studies to achieve the above objects and finally found that the use of a receptive layer containing an aliphatic dye fixing agent (an aliphatic quaternary ammonium salt) ensures to prevent generation of a harmful substance (e.g., benzyl chloride) but causes deterioration of color density; and the use of an receptive layer containing a polysaccharide or a derivative thereof (e.g., a cellulose derivative such as a hydroxyalkyl cellulose) and an aliphatic dye fixing agent in combination ensures to not only prevent generation of a harmful substance (e.g., benzyl chloride) but also improve color density of an image. The present invention was accomplished based on the above findings.

That is, the image-recording sheet of the present invention comprises (or has) a receptive layer on which an image is formable, wherein the receptive layer contains a film-formable resin component and a dye fixing agent. The film-formable resin component comprises a polysaccharide (or a carbohydrate) or a derivative thereof, and the dye fixing agent comprises an aliphatic dye fixing agent. In the image-recording sheet of the present invention, the receptive layer may be non-transferable, or transferable to an object. The image-recording sheet in which the receptive layer is transferable to an object (a transferable image-recording sheet) may comprise a substrate and a transfer layer, wherein the transfer layer is formed on and separable from the substrate and contains at least the receptive layer (for example, the transfer layer may contain the receptive layer alone, or both the receptive layer and a protective layer). The image-recording sheet of the present invention also includes an image-recording sheet comprising a substrate and a transfer layer, wherein the transfer layer is formed on and separable from the substrate and contains at least a receptive layer containing a hot-melt adhesive resin particle, a film-formable resin component and a dye fixing agent, and wherein the film-formable resin component comprises a polysaccharide or a derivative thereof, and the dye fixing agent comprises an aliphatic dye fixing agent. That is, the receptive layer constituting the transfer layer may further comprise the hot-melt adhesive resin particle, and the transfer layer may be separable from the substrate and transferable to an object. Incidentally, the transfer layer (e.g., the receptive layer alone) may be transferable to an object by separating the substrate from the image-recording sheet.

In the image-recording sheet, the polysaccharide or the derivative thereof may include, for example, a cellulose derivative [for example, a cellulose ether (e.g., a hydroxyalkyl cellulose), or a cellulose ester].

Moreover, the film-formable resin component may comprise the polysaccharide or the derivative thereof (e.g., the cellulose derivative such as the cellulose ether such as the hydroxyalkyl cellulose) and a hydrophilic polymer [for example, an oxyalkylene-series polymer having an oxyethylene unit (e.g., a water-soluble oxyethylene-series polymer such as a polyethylene glycol)] in combination. The proportion (weight ratio) of the polysaccharide or the derivative thereof relative to the hydrophilic polymer [the former/the latter] may be about 10/90 to 90/10.

Further, the film-formable resin component may comprise the polysaccharide or the derivative thereof and a urethane-series resin. The proportion (weight ratio) of the polysaccharide or the derivative thereof relative to the urethane-series resin [the former/the latter] may be about 5/95 to 90/10. The film-formable resin component may comprise the polysaccharide or the derivative thereof, the hydrophilic polymer, and urethane-series resin. In such a film-formable resin component, the ratio (weight ratio) of the total amount of the polysaccharide or the derivative thereof and the hydrophilic polymer relative to the urethane-series resin [the former/the latter] may be about 10/90 to 90/10.

As the dye fixing agent, various fixing agents, for example, a cationic compound (e.g., an aliphatic quaternary ammonium salt) may be utilized as long as the agent is aliphatic. The dye fixing agent may comprise an aliphatic quaternary ammonium salt having at least one long chain alkyl group. Moreover, the dye fixing agent may comprise at least one member selected from the group consisting of a tetraC₁₋₆alkylammonium halide, a triC₁₋₄alkylC₈₋₂₀alkylammonium halide (e.g., a trimethylC₈₋₁₆alkylammonium halide), and a diC₁₋₄alkyldiC₈₋₂₀alkylammonium halide. The proportion (weight ratio) of the polysaccharide or the derivative thereof (e.g., the cellulose derivative) relative to the aliphatic dye fixing agent [the former/the latter] may be, for example, about 10/90 to 70/30.

The hot-melt adhesive resin particle may comprise an aliphatic polyamide-series resin with a melting point of about 50 to 250° C., or may comprise at least a porous resin particle for enhancing ink-absorbency. For example, the hot-melt adhesive resin particle may comprise a porous resin particle and a non-porous resin particle. Further, the hot-melt adhesive resin particle may contain, for example, (A) a hot-melt adhesive resin particle with a melting point of higher than 80° C. and (B) a hot-melt adhesive resin particle with a melting point of not higher than 80° C.; and the hot-melt adhesive resin particle (A) may comprise (A1) a hot-melt adhesive resin particle with an oil absorption of not less than 50 ml/100 g and (A2) a hot-melt adhesive resin particle with an oil absorption of less than 50 ml/100 g.

On the receptive layer, an image can be recorded by various recording system, for example, an ink-jet recording system, an electrophotographic system, or a thermal recording system (e.g., a sublimation dye transfer thermal recording system, a thermofusible transfer thermal recording system, and a color developing thermal recording system). In particular, in the present invention, no harmful substance is generated from the receptive layer even when the image-recording sheet is heated. Therefore, the image-recording sheet of the present invention is suitable for an image-forming method utilizing a thermal action on the receptive layer (a thermally image-forming method). The present invention also includes a process for forming an image by using the image-recording sheet through a thermally image-forming system. The thermally image-forming method includes, for example, a thermal recording system (e.g., a sublimation dye transfer thermal recording system, a thermofusible transfer thermal recording system, and a color developing thermal recording system), an electrophotographic system, and in addition, an ink-jet recording system in combination with a transfer mechanism (a thermal transfer). Moreover, the present invention is also advantageously utilized for a process which comprises recording an image on the receptive layer of the image-recording sheet, contacting a transfer layer containing at least the image-recorded receptive layer (e.g., the receptive layer) with an object under heat, (after heating, if necessary, separating the substrate), and transferring the recorded image together with the transfer layer to the object.

The thermally image-forming method may comprise, for example, recording an image on the receptive layer by the above-mentioned various recording systems, and transferring a transfer layer containing at least the image-recorded receptive layer to an object through a thermal transfer, or comprise recording an image on the receptive layer by the above-mentioned various recording systems, contacting the transfer layer containing at least the image-recorded receptive layer with the object under heat (after heating, if necessary separating the substrate from the image-recording sheet), and transferring the recorded image together with the transfer layer to the object. Moreover, the thermally image-forming method may comprise recording an image on the receptive layer by the above-mentioned various recording systems, separating the substrate from the image-recording sheet, and then contacting the transfer layer containing at least the image-recorded receptive layer (e.g., the receptive layer) with the object under heat, and transferring the recorded image together with the transfer layer to the object.

The present invention also includes (a) a method for preventing or inhibiting the generation of a harmful substance by heating of an image-recording sheet, which comprises preventing or inhibiting the generation of the harmful substance (e.g., benzyl chloride) by using an image-recording sheet comprising the above-mentioned receptive layer as an image-recording sheet, and (b) a method for forming an image on a receptive layer by an ink-jet system or a sublimation dye transfer system, which comprises increasing the color density by using the above-mentioned image-recording sheet as an image-recording sheet.

Incidentally, the evaluation sheet for the safety of existing chemicals (hazard) pointed out mutagenicity, genotoxicity or of benzyl chloride. American Conference of Governmental Industrial Hygienists (ACGIH (1996)) describes that benzyl chloride is classified as Classification A3: animal cancerogenic substance and the threshold limit value thereof is 1 ppm (5.2 mg/m³). According to the present invention, harmful substances such as benzyl chloride are hardly generated, and therefore, the color density can be enhanced without degradation of the working environment or deterioration of the safety even when the image-forming sheet is subjected to a heating process or others.

### DETAILED DESCRIPTION OF THE INVENTION

The receptive layer (or image-receptive layer) of the image-recording sheet of the present invention comprises a film-formable resin component and a dye fixing agent, and may form an image thereon. The receptive layer may be a non-transferable receptive layer for utilizing an image formed thereon as it is, or may be a transferable receptive layer which may be transferable to an object. Moreover, in the image-recording sheet (the transferable image-recording sheet) for transferring to the object, a layer transferable to the object (a transfer layer) comprises at least the receptive layer. For example, a transfer layer comprising a receptive layer alone may be transferred, or a transfer layer comprising a receptive layer and other layer(s) (e.g., a protective layer) may be transferred.

Further, the image-recording sheet may comprise the receptive layer (or the transfer layer) alone, and the sheet is usually formed on a substrate in many cases. Incidentally, the receptive layer may integrally unite with the substrate. Moreover, the transfer layer (or the receptive layer, or others) may be separable from the substrate in order to transfer an image to the object. Incidentally, the substrate and the receptive layer may unite directly, or, if necessary, an anchor coat layer or an adhesive layer may be interposed between the substrate and the receptive layer.

[Substrate]

As the substrate, a various kinds of supports according to the usage may be used, and the examples may include a paper (e.g., a paper, a synthetic paper and a chemical fiber paper) and a plastic film. As the synthetic paper, various kinds of synthetic papers comprising a polypropylene or a polystyrene as a base may be used. The chemical fiber paper may be a nonwoven fabric, and the like.

A variety of resins (a thermoplastic resin or a thermosetting resin) may be used as a polymer constituting the plastic film. Usually, the thermoplastic resin is used. Examples of the thermoplastic resin may include a polyolefinic resin (e.g., a polyC₂₋₄olefinic resin such as a polypropylene), a cellulose derivative (e.g., a cellulose ester such as a cellulose acetate), a polyester-series resin (e.g., a polyalkylene terephthalate such as a polyethylene terephthalate or a polybutylene terephthalate, a polyalkylene naphthalate such as a polyethylene naphthalate or a polybutylene naphthalate, or a copolyester thereof), a polyamide-series resin (e.g., a polyamide 6 and a polyamide 6/6), a vinyl alcohol-series resin (e.g., a polyvinyl alcohol and an ethylene-vinyl alcohol copolymer), a polycarbonate-series resin, and others. Among these films, a polypropylene, a polyester-series resin, a polyamide-series resin, and the like are usually employed. In the view of mechanical strength and heat resistance, an aromatic polyester-series resin (especially, a polyalkylene arylate-series resin such as a polyethylene terephthalate) is particularly preferred. Incidentally, the substrate may be a complexed material in which the same or the different kinds of layers are laminated. Moreover, the substrate may be opaque, translucent or transparent. The thickness of the substrate may be selected depending on the use, and is usually about 10 to 250 μm, and more preferably about 15 to 200 μm.

The substrate from which the receptive layer (or the transfer layer) is separable may usually be a release (or releasable) substrate, for example, a release-treated paper (a releasable paper), a synthetic paper which releasing treatment may be performed to, or a plastic film which releasing treatment may be performed to. The releasability may be imparted by a conventional method such as treating the substrate with a release agent (e.g., wax, a salt of a higher fatty acid, an ester of a higher fatty acid, a higher fatty acid amide and silicone oil), or allowing the substrate to contain a release agent. In the case of the paper, for example, the releasability can be imparted by coating the paper with a release agent (e.g., a silicone oil) after an anchor treatment (e.g., a clay coat). To the plastic film may be added, if necessary, a conventional additive such as a stabilizer (e.g., antioxidant, an ultraviolet absorptive agent and a heat stabilizer), a lubricant, a nucleation agent, a filler, a pigment, or the like.

[Receptive Layer]

In the present invention the receptive layer may comprise a film-formable resin component and a dye fixing agent. In particular, the receptive layer may comprise a combination of a polysaccharide or the derivative thereof and an aliphatic dye fixing agent. Incidentally, when an aromatic dye fixing agent is used as the dye fixing agent, a bright image with high color density may be formed, however, a harmful substance (e.g., benzyl chloride) tends to be generated. On the other hand, when an aliphatic dye fixing agent is used in order to prevent generating a harmful substance, the color quality of an image deteriorates. In the present invention, the combination of the polysaccharide or the derivative thereof and the aliphatic dye fixing agent improves the color quality and increases the color density, and in addition effectively prevents generating a harmful substance (e.g., benzyl chloride) by heating.

The polysaccharide or the derivative thereof as the film-formable resin component may include a variety of compounds having a film-formability, for example, a cellulose derivative, a starch or a modified starch (e.g., an dextrin, an oxidized starch, an acid-immersed starch, an enzyme-treated starch, an alpha-starch (a pregelatinized starch), an ester of starch (e.g., an acetylated starch and a phosphoric ester), an ether of starch (e.g., a carboxymethyl starch), a crosslinked starch such as a starch phosphoric acid-crosslinked), a locust bean rubber, a gum arabic, a tragacanth rubber, a pectin, an alginic acid or a salt thereof (e.g., sodium alginate), carrageenan, hyaluronic acid, chondroitin sulfate, chitin, chitosan, polygalactosamine, carrageenan, curdlan, pullulan, xanthan, dextran, gelatin, casein, and others. These polysaccharides or the derivatives thereof may be used singly or in combination.

The cellulose derivative may comprise a cellulose ether and/or a cellulose ester. Examples of the cellulose ether may include an alkyl cellulose (e.g., a C₁₋₆alkyl cellulose such as a methyl cellulose, an ethyl cellulose, a propyl cellulose or a butyl cellulose), a hydroxyalkyl cellulose (e.g., a hydroxyC₂₋₄alkyl cellulose such as a hydroxyethyl cellulose or a hydroxypropyl cellulose, a hydroxyC₂₋₄alkylC₁₋₄alkyl cellulose such as a hydroxyethylmethyl cellulose, a hydroxypropylmethyl cellulose or a hydroxypropylethyl cellulose), a carboxyalkyl cellulose (e.g., a carboxymethyl cellulose or a salt thereof (e.g., a sodium salt), a carboxymethylC₁₋₄alkyl cellulose such as a carboxymethylethyl cellulose), a cyanoethyl cellulose, and a benzyl cellulose. The cellulose ester may include, for example, an ester of an organic acid (e.g., a celluloseC₂₋₆aliphatic carboxylate such as a cellulose acetate (e.g., a diacetate and a triacetate), a cellulose propionate or a cellulose butyrate), an ester of an inorganic acid (e.g., a nitrocellulose and a cellulose phosphate), and an ester of a mixed acid (e.g., a cellulose acetate C₃₋₆aliphatic carboxylate such as a cellulose acetate propionate or a cellulose acetate butyrate). Furthermore, the cellulose derivative may be a cellulose ether ester (e.g., a cellulose methyl acetate, a cellulose butyl acetate, a cellulose hydroxyethyl acetate, a cellulose hydroxypropyl acetate, and a cellulose hydroxypropyl butyrate). These cellulose derivatives may be used singly or in combination.

The mean degree of etherification (the mean substitution degree) of the cellulose ether may be, usually, about 0.5 to 2 (preferably about 0.7 to 1.8). The mean degree of acylation (the mean substitution degree) of the cellulose ester may be, for example, about 1 to 3, (preferably about 1.5 to 3, and more preferably about 2 to 3). Furthermore, in the cellulose ether ester, the mean degree of etherification (the mean substitution degree) may be about 0.1 to 2 (preferably about 0.3 to 1.5, and more preferably about 0.3 to 1), and the mean degree of acylation (the mean substitution degree) may be, for example, about 0.5 to 2.9 (preferably about 1 to 2.8, and more preferably about 1.5 to 2.5).

The polysaccharide or the derivative thereof may be selected depending on the image-forming method, and usually the cellulose derivative (the cellulose ether and/or the cellulose ester) is used. For example, when an image is formed by using an aqueous coloring agent (e.g., an aqueous ink containing a coloring agent such as a dye or a pigment), followings may be used as the polysaccharide or a derivative thereof (e.g., the cellulose derivative): a hydrophilic or aqueous polysaccharide or a derivative thereof, for example, the alkyl cellulose (e.g., the alkyl cellulose such as a methyl cellulose, and the hydroxyalkyl cellulose such as a hydroxypropyl cellulose). As the hydrophilic or aqueous derivative, the hydroxyalkyl cellulose (e.g., a hydroxypropyl cellulose) may be used in many cases. Moreover, when an image is formed by using an oil-based coloring agent or a sublimation dye, as the polysaccharide or the derivative thereof (e.g., the cellulose derivative), the hydrophilic or aqueous derivative may be used, and usually a water-insoluble or hydrophobic polysaccharide or a derivative thereof, for example, a C₂₋₆alkyl cellulose, a cellulose ester and a cellulose ether ester may be usually employed.

The polysaccharide or the derivative thereof (e.g., the cellulose derivative) may be used in combination with other film-formable resin component(s). Other film-formable resin component(s) is not particularly limited to a specific one, and there may be mentioned a variety of thermoplastic resins (e.g., a polyamide-series resin, a polyester-series resin, a polycarbonate-series resin, a thermoplastic urethane-series resin, a polyvinyl acetate-series resin, a styrenic resin, an acrylic resin, a vinyl chloride-series resin and a polyolefinic resin), and others. These film-formable resin components may be used singly or in combination. The species of these film-formable resin components may be selected depending on the image-forming method, and in the case where an image is formed by the aqueous coloring agent, the hydrophilic film-formable resin component, for example, at least one member selected from a hydrophilic polymer and a urethane-series resin is used in many cases.

In the combination use of the polysaccharide or the derivative thereof (e.g., the cellulose derivative) and other film-formable resin component(s), the ratio (weight ratio) of the former relative to the latter may be, for example, about 5/95 to 95/5 (e.g., about 10/90 to 90/10), preferably about 10/90 to 80/20 (e.g., 15/85 to 70/30), and more preferably about 15/85 to 60/40 (e.g., about 20/80 to 50/50).

(1) Hydrophilic Polymer

The hydrophilic polymer may include a water-soluble polymer, a water-dispersable polymer and a water-absorbing polymer insoluble to water. The hydrophilic polymer may include, for example, an oxyalkylene-series polymer, a (meth)acrylic acid-series polymer [e.g., a homo- or copolymer of (meth)acrylic acid, or the salt thereof], a vinyl ether-series polymer (e.g., a homo- or copolymer of a vinyl alkyl ether), a styrenic polymer [e.g., a styrene-maleic anhydride copolymer and a styrene-(meth)acrylic acid copolymer, or a salt thereof], a vinyl acetate-series polymer (e.g., a homo- or copolymer of vinyl acetate), a vinyl alcohol-series polymer (e.g., a polyvinyl alcohol, a modified polyvinyl alcohol and an ethylene-vinyl alcohol copolymer), a nitrogen-containing polymer (or a cationic polymer) or the salt thereof [e.g., a quaternary ammonium salt such as a polydiallyldimethylammonium chloride, a polydimethylaminoethyl(meth)acrylate hydrochloride, a polyethylene imine, a polyacrylamide and a polyvinyl pyrrolidone], and others. The salt of the hydrophilic polymer may include an ammonium salt, an amine salt and a salt of an alkali metal such as sodium. These hydrophilic polymers may be used singly or in combination.

Among these hydrophilic polymers, a hydrophilic polymer containing a hydroxyl group (e.g., an oxyalkylene-series polymer and a vinyl alcohol-series polymer), a hydrophilic polymer containing a carboxyl group (e.g., an acrylic polymer), a nitrogen-containing polymer (e.g., a cationic polymer and a polyvinylpyrrolidone), and the like are preferred.

The film-formable resin component may comprise in combination of the polysaccharide or the derivative thereof (e.g., the cellulose derivative such as the hydrophilic or water-soluble cellulose derivative) and the hydrophilic polymer (e.g., the oxyalkylene-series polymer). The oxyalkylene-series polymer may include a polyoxyC₂₋₄alkylene glycol (e.g., a polyethylene glycol, a polypropylene glycol and a polytetramethylene ether glycol). The oxyalkylene-series polymer may comprise, in many cases, an oxyethylene-series polymer having at least an oxyethylene unit. The oxyalkylene-series polymer may include, for example, a polyethylene glycol (homopolymer), a copolymer of ethylene oxide and a C₃₋₄alkylene oxide (e.g., a random copolymer and a polyoxyethylene-polyoxypropylene block copolymer), and a copolymer of ethylene oxide and a compound having an active hydrogen atom [at least one active compound selected from a hydroxyl group-containing compound (e.g., a polyhydric alcohol such as an alkylene glycol, glycerin, a trimethylolpropane or a bisphenol), a carboxyl group-containing compound (e.g., a C₂₋₄carboxylic acid such as acetic acid, propionic acid and butyric acid) and an amino group-containing compound (e.g., an amine, an alkanolamine such as ethanolamine)]. The oxyalkylene-series polymer may be a water-soluble polymer. These oxyalkylene-series polymers may be used singly or in combination.

The weight-average molecular weight of the hydrophilic polymer may be selected within the range of about 100 to 100000, preferably about 500 to 50000, and more preferably about 1000 to 30000.

In the combination use of the polysaccharide or the derivative thereof (e.g., the cellulose derivative) and the hydrophilic polymer (e.g., the oxyalkylene-series polymer), the ratio (weight ratio) of the former relative to the latter is, for example, about 10/90 to 90/10, preferably about 15/85 to 70/30, and more preferably about 20/80 to 50/50.

(2) Urethane-Series Resin

The receptive layer (the transfer layer for the transferable receptive layer) may contain a urethane-series resin to improve texture (softness) of the receptive layer. The urethane-series resin may be obtained by, for example, a reaction of a diisocyanate component and a diol component, and if necessary, a diamine component may be used as a chain-extending agent.

The diisocyanate component may include an aromatic diisocyanate (e.g., a tolylene diisocyanate), an araliphatic diisocyanate (e.g., a xylene diisocyanate), an alicyclic diisocyanate (e.g., an isophorone diisocyanate), an aliphatic diisocyanate (e.g., 1,6-hexamethylene diisocyanate and a lysine diisocyanate), and the like. The diisocyanate component may be an adduct, and may be used in combination with a polyisocyanate component such as triphenyl methane triisocyanate, if necessary. The diisocyanate component may be used singly or in combination.

As the diol component, there may be exemplified a polyester diol, a polyether diol, a polycarbonate diol, and others. The diol component may be used singly or in combination.

The polyester diol may be obtained by a reaction between a diol (e.g., a C₂₋₁₀alkylene glycol such as ethylene glycol or 1,4-butanediol; and a polyoxy C₂₋₄alkylene glycol such as diethylene glycol) and a dicarboxylic acid [an aliphatic dicarboxylic acid (e.g., a C₄₋₁₄aliphatic dicarboxylic acid such as adipic acid), an alicyclic dicarboxylic acid, and an aromatic dicarboxylic acid (e.g., phthalic acid, terephthalic acid and isophthalic acid)] or a reactive derivative thereof (a lower alkyl ester and an acid anhydride). The polyester diol may be obtained by a homopolymerization of a lactone [e.g., a C₄₋₁₂lactone such as caprolactone or laurolactone] or a reaction among the lactone, the diol and the dicarboxylic acid. Incidentally, if necessary, the diol, the dicarboxylic acid and the lactone may be used in combination with a polyol (e.g., glycerin, trimethylolpropane and pentaerythritol), a polycarboxylic acid (e.g., trimellitic acid and pyromellitic acid) and others.

The urethane-series resin may include a polyether-based urethane-series resin obtained from the polyether diol (such as a polyoxytetramethylene glycol) as a diol component, and a polyester-based urethane-series resin obtained from at least the polyester diol.

The urethane-series resin is used as an organic solvent solution, an aqueous solution, or an aqueous emulsion. The aqueous solution or an aqueous emulsion of the urethane-series resin may be prepared by dissolving or emulsion-dispersing the urethane-series resin with the use of an emulsifier, or may be prepared by dissolving or dispersing the urethane-series resin with an alkali or an acid after introducing an ionic functional group into the urethane-series resin intramolecularly with the use of a diol (particularly a diol with high molecular weight) component having the ionic functional group (such as a free carboxyl group, a sulfonic acid group or a tertiary amino group). Incidentally, the diol having a free carboxyl group (particularly, a diol with a high molecular weight) may, for example, be obtained by a reaction of a diol component with a polycarboxylic acid having not less than three carboxyl groups or an anhydride thereof (e.g., a tetracarboxylic dianhydride such as pyromellitic dianhydride), or with a polycarboxylic acid having a sulfonic acid group (e.g., a sulfoisophthalic acid), by a reaction of a dihydroxycarboxylic acid (e.g., dimethylolpropionic acid) with a dicarboxylic acid, or by a method using a dihydroxycarboxylic acid (e.g., dimethylolpropionic acid) as an initiator and the lactone. Moreover, a diol having a tertiary amino group (particularly, a diol with a high molecular weight) may be prepared by a reaction of N-methyl diethanolamine as an initiator with an alkylene oxide (particularly ethylene oxide) or the lactone. The tertiary amino group may form a quaternary ammonium salt. The urethane-series polymer which the tertiary amino group or the quaternary ammonium salt is introduced into [a cationic-based urethane-series resin (a cationic urethane-series resin)] is commercially available as, e.g., F-8559D (manufactured by Dai-ichi Kogyo Seiyaku Co., Ltd.), and PERMARIN UC-20 (manufactured by Sanyo Chemical Industries, Ltd.). The urethane-series resin may be used singly or in combination.

The ratio (weight ratio) of the polysaccharide or the derivative thereof (e.g., the cellulose derivative) relative to the urethane-series resin [the former/the latter] may be, for example, about 5/95 to 90/10, preferably about 10/90 to 80/20, and more preferably about 15/85 to 60/40 (e.g., about 20/80 to 50/50). The ratio (weight ratio) of the total amount of the polysaccharide or the derivative thereof (e.g., the cellulose derivative) and the hydrophilic polymer relative to the urethane-series resin [the former/the latter] is, for example, about 90/10 to 10/90, preferably about 70/30 to 30/70, and more preferably about 60/40 to 40/60.

The film-formable resin component may be used in combination with a curable resin component (a curable film-formable resin component) such as a thermosetting or crosslinkable resin. The curable resin component may be the thermosetting resin (e.g., an unsaturated polyester resin, an epoxy-series resin, a vinyl ester-series resin, and a silicone-series resin), and usually, a self-crosslinkable resin (e.g., a thermoplastic resin having a self-crosslinkable group). The self-crosslinkable resin may include a polymer which is composed of, as a constitutional unit, a monomer containing at least a self-crosslinkable group [e.g., an epoxy group, a methylol group, a hydrolyzed condensate group (e.g., silyl group), and an aziridinyl group], for example, a polyester-series resin, a polyamide-series resin, and an acrylic resin. The thermosetting or crosslinkable resin may be used singly or in combination. The preferred crosslinkable resin is a self-crosslinkable acrylic resin.

Examples of the monomer having the self-crosslinkable group may include an epoxy group-containing monomer [e.g., glycidyl(meth)acrylate], a methylol group-containing monomer or a derivative thereof [e.g., N-methylol (meth)acrylamide, and N—C₁₋₄alkoxymethyl (meth)acrylamide], a hydrolyzed condensate group-containing monomer such as silyl group or an alkoxysilyl group [e.g., a vinylalkoxysilane such as a vinyltriC₁₋₂alkoxysilane, a vinyldiC₁₋₂alkoxymethylsilane, a vinylC₁₋₂alkoxydimethylsilane, a vinyltris(2-methoxyethoxy)silane, a divinyldiC₁₋₂alkoxysilane, or a divinyldi(alkoxyalkyl)silane [e.g., a divinyldi(2-methoxyethoxy)silane]; a vinylacetoxysilane such as a vinyldiacetoxymethylsilane, or a vinyltriacetoxysilane; a vinylhalosilane such as a vinylmethydichlorosilane or a vinyltrichlorosilane; an allylalkoxysilane such as an allyltriC₁₋₂alkoxysilane; an allylhalosilane such as an allyltrichlorosilane; a (meth)acryloyloxyalkylalkoxysilane or a corresponding halosilane such as 2-(meth)acryloyloxyethyltriC₁₋₂alkoxysilane, 3-(meth)acryloyloxypropyltriC₁₋₂alkoxysilane, 3-(meth)acryloyloxypropylmethyldiC₁₋₂alkoxysilane, and 3-(meth)acryloyloxypropylmethyldichlorosilane], an aziridinyl group-containing monomer [e.g., 2-(1-aziridinyl)ethyl(meth)acrylate and 2-(1-aziridinyl)propyl(meth)acrylate], and the like. The crosslinkable functional group-containing monomers may be used singly or in combination.

The preferred crosslinkable functional group-containing monomers may contain a hydrolyzed condensate group, particularly an alkoxysilyl group (methoxysilyl group or ethoxysilyl group). It is preferred to use an acrylic resin having a hydrolyzed condensate group (e.g., an acrylic silicone resin) and others as the thermosetting or the crosslinkable resin.

The thermosetting or crosslinkable resin may comprise the crosslinkable functional group-containing monomer and other monomer(s) (a monomer such as a cationic functional group-containing monomer, a hydrophilic monomer, or a non-ionic monomer). The cationic functional group-containing monomer may include, for example, a diC₁₋₄alkylamino-C₂₋₃alkyl(meth)acrylamide or a salt thereof, diC₁₋₄alkylamino-C₂₋₃alkyl(meth)acrylate or a salt thereof, a nitrogen-containing heterocyclic monomer or a salt thereof [e.g., vinylpyridine, vinylimidazole, and vinylpyrrolidone] and the like. As the salt, there may be exemplified a salt of halogenated hydracid, a sulfate, an alkyl sulfate, an alkyl sulfonate, an aryl sulfonate, a carboxylate, (e.g., an acetate), and others. As the salt, there may be exemplified a salt of a halogenated hydracid, a sulfate, an alkyl sulfate, an alkyl sulfonate, an aryl sulfonate, a carboxylate (e.g., an acetate), and others. The cationic functional group-containing monomer may be used singly or in combination. Incidentally, a quaternary ammonium salt group may be produced by allowing a tertiary amino group to react with an alkylating agent (e.g., epichlorohydrin, methyl chloride and benzyl chloride).

The hydrophilic monomer includes a carboxyl group- or acid anhydride group-containing monomer [e.g., (meth)acrylic acid and maleic anhydride], a hydroxyl group-containing monomer [e.g., 2-hydroxyethyl (meth)acrylate and 2-hydroxypropyl(meth)acrylate], an amide group-containing monomer [e.g., (meth)acrylamide], a sulfonic acid group-containing monomer or a salt thereof [e.g., a styrenesulfonic acid and a vinylsulfonic acid], an ether group-containing monomer [e.g., a vinyl C₁₋₆alkyl ether], a polyoxyalkylene group-containing monomer [e.g., diethylene glycol mono(meth)acrylate and a polyethylene glycol mono(meth)acrylate], and the like. The above hydrophilic monomer may be used singly or in combination.

The non-ionic monomer may include, for example, a (meth)acrylic monomer [e.g., a C₁₋₁₈alkyl ester of (meth)acrylic acid, cyclohexyl(meth)acrylate, phenyl (meth)acrylate, and benzyl(meth)acrylate], an aromatic vinyl compound [e.g., styrene, vinyl toluene, α-methyl styrene], a vinyl ester of a carboxylic acid [e.g., vinyl acetate and vinyl versatate]. The non-ionic monomer may also be used singly or in combination. As the non-ionic monomer, it is usual to employ a C₂₋₁₀alkyl ester of acrylic acid or a C₁₋₆alkyl ester of methacrylic acid, styrene or vinyl acetate.

In the total monomers, the content of the crosslinkable functional group-containing monomer may be about 0.1 to 20% by weight, preferably about 0.1 to 10% by weight, and more preferably about 1 to 5% by weight; the content of the cationic monomer may be about 1 to 50% by weight, and preferably about 5 to 45% by weight; the content of the hydrophilic monomer may be about 0 to 30% by weight (e.g., about 0.1 to 30% by weight), preferably about 0.1 to 20% by weight, and more preferably about 0.5 to 15% by weight, and the rest comprises anon-ionic monomer. In the preferred embodiment, the proportions of the monomers relative to 100 parts by weight of the crosslinkable functional group-containing monomer are as follows; the proportion of the cationic functional group-containing monomer is about 300 to 1000 parts by weight, and preferably about 500 to 800 parts by weight; and that of the hydrophilic monomer is about 100 to 500 parts by weight, and preferably about 200 to 300 parts by weight.

The content of the curable resin component (e.g., the curable film-formable resin component such as the thermosetting or the crosslinkable resin) may be suitably selected within the range of about 0 to 90% by weight, relative to the total film-formable resin components. The ratio (weight ratio) of the polysaccharide or the derivative thereof (e.g., the cellulose derivative) relative to the curable resin component [the former/the latter] may be, for example, about 5/95 to 90/10, preferably about 10/90 to 80/20, and more preferably about 15/85 to 60/40 (e.g., about 20/80 to 50/50).

The thermosetting or crosslinkable resin may be in the form of a solution such as an organic solvent solution or an aqueous solution, and usually in the form of an emulsion (particularly an aqueous emulsion). The emulsion containing a crosslinkable polymer may be obtained by a conventional method, for example, a method which comprises emulsion polymerizing the monomer(s) in an emulsion polymerization system containing a nonionic detergent (or surfactant) and/or a cationic detergent (or surfactant), and a method which comprises emulsion polymerizing the monomer, and then forming a tertiary amine salt or a quaternary ammonium salt to give an aqueous emulsion.

Incidentally, the thermosetting or the crosslinkable resin, the urethane-series resin and the hydrophilic polymer may be used in combination, for example, by mixing them beforehand. Moreover, the thermosetting or the crosslinkable resin and the urethane-series resin may be used as a complexed (or grafted) product, for example, obtained by a method of emulsion polymerizing a monomer containing an acrylic monomer (particularly, a cationic monomer), in the presence of an emulsion the urethane-series resin.

[Dye Fixing Agent]

The dye fixing agent may be an aliphatic dye fixing agent which is capable of improving fixing property of a coloring agent (dye), and may be a dye fixing agent having a low molecular weight or a high molecular weight. Moreover, the dye fixing agent may comprise a combination of the dye fixing agent having a low molecular weight and the dye fixing agent having a high molecular weight. Incidentally, the term “dye fixing agent” is used in the same meaning as “dye adhesive (sticking) agent”. The dye fixing agent is usually a cationic compound (e.g., an aliphatic quaternary ammonium salt), in many cases.

(1) Low Molecular Weight Dye Fixing Agent

The low molecular dye fixing agent may be an aliphatic amine salt, and usually an aliphatic quaternary ammonium salt (a cationic dye fixing agent) is employed. The aliphatic quaternary ammonium salt contains, in many cases, at least one long chain alkyl group (e.g., a C₆₋₂₀alkyl group).

The aliphatic quaternary ammonium salt may include, for example, a tetraC₁₋₆alkylammonium halide (e.g., tetramethylammonium chloride, tetraethylammonium chloride, tetramethylammonium bromide and tetraethylammonium bromide), a triC₁₋₄alkylC₈₋₂₀alkylammonium halide (e.g., trimethyllaurylammonium chloride and trimethyllaurylammonium bromide), a diC₁₋₄alkyldiC₈₋₂₀alkylammonium halide (e.g., dimethyldilaurylammonium chloride and dimethyldilaurylammonium bromide), and others. These quaternary ammonium salts may be used singly or in combination. The preferred quaternary ammonium salt includes a triC₁₋₄alkylC₁₀₋₁₆alkylammonium halide (e.g., a triC₁₋₂alkylC₁₀₋₁₄alkylammonium halide), a diC₁₋₄alkyldiC₁₀₋₁₆alkylammonium halide (e.g., a diC₁₋₂alkyldiC₁₀₋₁₄alkylammonium halide), a diallyldiC₁₋₄alkylammonium halide (e.g., a diallyldimethylammonium chloride), and the like. The aliphatic ammonium salt and the quaternary ammonium salt are commercially available as, for example, “ACTEX FC-7”, (manufactured by Morin Chemical Industries Co., Ltd.) and as “CATIOGEN L”, (manufactured by Dai-ichi Kogyo Seiyaku Co., Ltd.), respectively.

(2) High Molecular Weight Dye Fixing Agent

The high molecular weight dye fixing agent usually has a cationic group (in particular, a strong cationic group such as a guanidyl group or a quaternary ammonium salt-type group) in the molecule thereof. The high molecular weight dye fixing agent may include, for example, a dicyane-series compound (e.g., a dicyanediamide-formaldehyde polycondensate), a polyamine-series compound [e.g., an aliphatic polyamine such as diethylenetriamine, an aromatic polyamine such as phenylenediamine, a condensate of a dicyandiamide and a (poly)C₂₋₄alkylenepolyamine (e.g., a dicyanediamide-diethylenetriamine polycondensate)], a polycationic compound, and the like. Examples of the polycationic compound may include an epichlorohydrine-diC₁₋₄alkylamine adduct polymer (e.g., an adduct polymer of an epichlorohydrin-dimethylamine), a polymer of an allylamine or a salt thereof (e.g., a polymer of an allylamine or a salt thereof, and a polymer of a polyallylamine or a hydrochloride thereof), a polymer of a diallylC₁₋₄alkylamine or a salt thereof (e.g., a polymer of a diallylmethylamine or a salt thereof), a polymer of a diallyldiC₁₋₄alkylammonium salt (e.g., a polymer of a diallyldimethylammonium chloride), a copolymer of a diallylamine or a salt thereof and a sulfur dioxide (e.g., a diallylamine salt-sulfur dioxide copolymer), a diallyldiC₁₋₄alkylammonium salt-sulfur dioxide copolymer (e.g., diallyldimethylammonium salt-sulfur dioxide copolymer), a copolymer of a diallyldiC₁₋₄alkylammonium salt and a diallylamine or a salt thereof or a derivative thereof (e.g., a copolymer of a diallyldimethylammonium salt and a diallylamine hydrochloride derivative), a diallyldiC₁₋₄alkylammonium salt polymer (e.g., diallyldimethylammonium salt polymer), a polymer of a quaternary salt of dialkylaminoethyl(meth)acrylate [e.g., a diC₁₋₄alkylalkylaminoethyl(meth)acrylate quaternary salt polymer], a diallyldiC₁₋₄alkylammonium salt-acrylamide copolymer (e.g., a diallyldimethylammonium salt-acrylamide copolymer), an amine-carboxylic acid copolymer, and the like. These high molecular weight dye fixing agents may be used singly or in combination.

Among these dye fixing agents, it is preferred to use an alkylammonium halide (e.g., an alkylammonium halide having at least one long chain alkyl group), for example, a tri(short chain alkyl)-long chain alkylammonium halide (e.g., a triC₁₋₂alkylC₈₋₁₆alkylammonium halide), and/or a di(short chain alkyl)di(long chain alkyl)ammonium halide (e.g., a diC₁₋₂alkyldiC₈₋₂₀alkylammonium halide). As the dye fixing agent, a trimethylC₈₋₁₆alkylammonium halide is particularly used in many cases.

The ratio (weight ratio) of the polysaccharide or the derivative thereof (e.g., the cellulose derivative) relative to the aliphatic dye fixing agent [the former/the latter] is about 10/90 to 70/30, preferably about 15/85 to 60/40, and more preferably about 20/80 to 50/50 (e.g., about 20/80 to 40/60). The ratio (weight ratio) of the dye fixing agent relative to the film-formable resin component may be, on solid bases, about 10 to 100 parts by weight, preferably about 20 to 80 parts by weight, and more preferably about 25 to 75 parts by weight (e.g., about 30 to 60 parts by weight), relative to 100 parts by weight of the film-formable resin component.

The receptive layer may contain a variety of components depending on the usage mode of the image. For example, when the receptive layer allows to unite with the object or transfers to the object, the receptive layer may contain an adhesive component. The adhesive component may comprise a pressure-sensitive adhesive. In order to improve feeding property of the image-recording sheet in an image-forming apparatus, to keep (not to damage) the formability of the image, and to improve adhesiveness to the object by thermal adhesion, it is advantageous that the adhesive component comprises a hot-melt adhesive resin particle.

Examples of the hot-melt adhesive resin may include various resins, for example, an olefinic resin (e.g., a polyethylene, an ethylene-propylene copolymer, and an atactic polypropylene), an ethylene copolymer resin [e.g., an ethylene-vinyl acetate copolymer, an ethylene-(meth)acrylic acid copolymer, an ethylene-ethyl acrylate copolymer and an ionomer], a polyamide-series resin, a polyester-series resin, a polyurethane-series resin, an acrylic resin and a rubber. The hot-melt adhesive resin may be used singly or in combination. The hot-melt adhesive resin is usually water-insoluble. The hot-melt adhesive resin may be a reactive hot-melt adhesive resin having a reactive group (e.g., carboxyl group, hydroxyl group, amino group, isocyanate group and silyl group) at the terminal.

The preferred resin which imparts thermal transferability and durability (e.g., washing resistance) to the receptive layer is a polyamide (or a nylon)-series resin, a polyester-series resin, or a polyurethane-series resin. In particular, the hot-melt adhesive resin comprising the polyamide-series resin is capable of imparting high washing resistance, water resistance, and high quality of texture to the transferred image, in the case where the object is soft one such as clothing.

As the polyamide-series hot-melt adhesive resin, there may include a polyamide (nylon) 66, a polyamide 610, a polyamide 611, a polyamide 612, a polyamide 9, a polyamide 11, a polyamide 12, a polyamide 66/11, a polyamide 66/12, a polyamide resin generated from a reaction of a dimer acid and a diamine, a polyamide-based elastomer (e.g., a polyamide using a polyoxyalkylene diamine as a soft segment), and others. These polyamide-series resins may be used singly or in combination. These resins include a polyamide having at least one constitutional unit selected from a polyamide 11 and a polyamide 12 (e.g., a homopolyamide such as a polyamide 11 or a polyamide 12, and a copolyamide such as a polyamide 6/11, a polyamide 6/12, a polyamide 66/12, or a copolymer of a dimer acid, a diamine and laurolactam or aminoundecanoic acid), and a polyamide resin generated from a reaction of a dimer acid and a diamine.

The polyester-series hot-melt adhesive resin includes a homo- or copolyester resin and a polyester-series elastomer, in which at least an aliphatic diol or an aliphatic dicarboxylic acid is used. The homopolyester resin includes a saturated aliphatic polyester resin formed by a reaction of an aliphatic diol (e.g., a C₂₋₁₀alkylene glycol and a (poly)oxyC₂₋₄alkylene glycol such as diethylene glycol), an aliphatic dicarboxylic acid (e.g., a C₄₋₁₄aliphatic dicarboxylic acid such as adipic acid, suberic acid, azelaic acid, sebacic acid or dodecanedicarboxylic acid), and if necessary, a lactone (e.g., butyrolactone, valerolactone, caprolactone and laurolactone). The copolyester resin includes a copolyester resin in which a part of the aliphatic dicarboxylic acid constituting the above-mentioned saturated aliphatic polyester resin is replaced with an aromatic dicarboxylic acid component, a saturated polyester resin in which a part of the constitutive component (a diol and/or terephthalic acid) of a polyethylene terephthalate or a polybutylene terephthalate is replaced with other diol (e.g., a C₂₋₆alkylene glycol, a (poly)oxyalkylene glycol such as diethylene glycol, and cyclohexanedimethanol) or a dicarboxylic acid (e.g., the above-mentioned aliphatic dicarboxylic acid, and an asymmetric aromatic dicarboxylic acid such as phthalic acid or isophthalic acid), or the above-mentioned lactone. The polyester-series elastomer includes an elastomer containing a C₂₋₄alkylene arylate (e.g., ethylene terephthalate and butylene terephthalate) as a hard segment and a (poly)oxyalkylene glycol and the like as a soft segment. As the polyester-series resin, there may be employed a polyester resin having a urethane bond, for example, the polyester resin increased a molecular weight thereof with the use of the diisocyanate. These polyester-series resins may be used singly or in combination.

The polyurethane-series hot-melt adhesive resin includes a polyurethane resin, in which a polyester diol corresponding to the polyester-series resin, or a polyether diol (e.g., a polyoxytetramethylene glycol) is used as at least a part of the diol component. As the diisocyanate component, there may be used an aromatic diisocyanate, an araliphatic diisocyanate, an alicyclic diisocyanate or an aliphatic diisocyanate. These polyurethane-series resins may be used singly or in combination.

The preferred hot-melt adhesive resin particle may comprise an aliphatic polyamide-series resin (particularly, a homo- or copolyamide-series resin containing a constitutional unit of a polyamide 11 and/or a polyamide 12).

The melting point of the hot-melt adhesive resin particle may be usually selected within the range of about 50 to 250° C. (e.g., about 70 to 220° C.), preferably about 60 to 200° C. (e.g., about 70 to 170° C.), and more preferably about 70 to 150° C. (e.g., about 100 to 150° C.).

The mean particle size (diameter) of the hot-melt adhesive resin particle may be selected properly within the range of not deteriorating the adhesiveness. It is advantageous to protrude the hot-melt adhesive resin particle from the surface of the receptive layer for expressing effectively the hot-melt adhesiveness. Therefore, at least a part of the hot-melt adhesive resin particle may have the larger mean particle size than the thickness of the receptive layer. The mean particle size of the resin particle is, for example, about 1 to 125 μm (e.g., about 5 to 100 μm), preferably about 3 to 120 μm (e.g., about 3 to 80 μm), more preferably about 5 to 120 μm (e.g., about 5 to 50 μm), and usually about 10 to 100 μm.

The hot-melt adhesive resin particle may be a non-porous or porous resin particle. Moreover, the hot-melt adhesive resin particle may comprise a combination of the porous resin particle and the non-porous resin particle. It is advantageous to improve the paper feeding-stability and the ink-absorbency of the receptive layer by using the porous resin particle.

The oil absorption of the porous resin particle may be not less than 50 ml/100 g (e.g., about 70 to 500 ml/100 g), and preferably about 75 ml/100 g e.g., about 100 to 300 ml/100 g). Incidentally, the oil absorption is measured using linseed oil in accordance with JIS K 5107 (JIS; Japanese Industrial Standards). The relative surface area of the porous resin particle may be about 5 to 100 m²/g (e.g., about 10 to 50 m²/g), and more preferably about 10 to 40 m²/g. Incidentally, the melting point of the porous resin particle may be selected within the above-mentioned range. The melting point may be usually higher than 80° C., for example, about 85 to 200° C., preferably about 90 to 170° C., and more preferably about 100 to 150° C. Incidentally, some commercially available porous resin particles have a relatively high melting point such as about 130 to 160° C. In order to generate effectively the hot-melt adhesiveness of the receptive layer, the porous resin particle may have a relatively large mean size, e.g., about 1 to 200 μm, preferably about 10 to 150 m, and more preferably about 30 to 100 μm.

The oil absorption of the non-porous resin particle may be less than 50 ml/100 g (e.g., about 0 to 48 ml/100 g preferably about 0 to 47 ml/100 g (e.g., about 10 to 47 ml/100 g)). Incidentally, the mean size of the non-porous resin particle may be the same as that of the porous resin particle.

The melting point of the non-porous resin particle may be the same as that of the porous resin particle. However, in order to impart the high hot-melt adhesiveness to the receptive layer, the non-porous resin particle usually has a lower melting point than the porous resin particle has, in many cases. The non-porous resin particle may often comprise at least a resin particle with a low melting point. The melting point of the non-porous resin particle may be usually about 30 to 200° C., preferably about 50 to 170° C. (e.g., about 90 to 160° C.), and more preferably about 60 to 150° C. (e.g., about 70 to 130° C.). The melting point of the non-porous resin particle with a low melting point may be not higher than 80° C. (e.g., about 40 to 80° C., preferably about 50 to 80° C., and more preferably about 60 to 80° C.).

The ratio (weight ratio) of the porous resin particle relative to the non-porous resin particle [the former/the latter] may be selected within the range of about 5/95 to 90/10, and may be usually about 10/90 to 90/10 (e.g., about 10/90 to 60/40), preferably about 10/90 to 50/50, and more preferably about 10/90 to 40/60 (particularly, about 10/90 to 30/70).

Furthermore, the hot-melt adhesive resin particle may comprise (A) a resin particle with a high melting point and (B) a resin particle with a low melting point, and the resin particle with a high melting point (A) may comprise a porous resin particle (A1) and a non-porous resin particle (A2). The melting point of the resin particle with a high melting point (A) may, for example, be higher than 80° C., (e.g., about 90 to 170° C., preferably about 100 to 160° C., and more preferably about 110 to 150° C.). The melting point of the resin particle with a low melting point (B) may be not higher than 80° C., (e.g., about 40 to 80° C., preferably about 50 to 80° C., and more preferably about 60 to 80° C.). Furthermore, the oil absorptions of the porous resin particle (A1) and the non-porous resin particle (A2) constituting the resin particle with a high melting point (A) may be same as described above.

The ratio (weight ratio) of the resin particle with a high melting point (A) relative to the resin particle with a low melting point (B) [(A)/(B)] is about 99.9/0.1 to 30/70, preferably about 99.5/0.5 to 50/50, and more preferably about 99/1 to 70/30 (particularly about 98/2 to 80/20). The ratio (weight ratio) of the porous resin particle (A1) relative to the non-porous resin particle (A2) [(A1)/(A2)] is about 80/20 to 1/99, preferably about 60/40 to 5/95, and more preferably about 40/60 to 10/90 (e.g., about 30/70 to 15/85).

The proportion of the hot-melt adhesive resin particle relative to 100 parts by weight of the film-formable resin component is, on solid bases, about 10 to 10000 parts by weight (e.g., about 10 to 5000 parts by weight), preferably about 10 to 3000 parts by weight (e.g., about 10 to 2000 parts by weight), and more preferably about 100 to 1000 parts by weight (e.g., about 150 to 1000 parts by weight), and usually about 150 to 5000 parts by weight.

(Additive)

The receptive layer may contain, if necessary, a variety of additives, for example, other dye fixing agent(s), a stabilizer (e.g., an antioxidant, an ultraviolet ray absorber and a heat stabilizer), an antistatic agent, a flame retardant, a lubricant, an antiblocking agent, a filler, a coloring agent, an antifoaming agent, a coatability improvable agent, and a thickener. The hot-melt adhesive resin particle may contain a tackifier (e.g., rosin or a derivative thereof, and a hydrocarbon-series resin), a wax and the like in addition to the above additive(s).

The thickness of the receptive layer is, for example, about 5 to 100 μm, preferably about 10 to 70 μm (e.g., about 10 to 60 μm), more preferably about 10 to 50 μm (e.g., about 20 to 40 μm), and usually about 5 to 60 μm (particularly about 10 to 50 μm). Incidentally, when the receptive layer contains the hot-melt adhesive resin particle, the thickness of the receptive layer means the least thickness of the coated layer formed by the coating agent containing the hot-melt adhesive resin particle.

If necessary, a porous layer, an antiblocking layer, a lubricant layer, an antistatic layer, and other layers may be formed on the surface of the receptive layer.

[Protective Layer]

In the image-recording sheet in which at least the receptive layer (the transfer layer containing at least the receptive layer) is transferable, the transfer layer may comprise the receptive layer and a protective layer in order to protect the receptive layer transferred to the object. That is, in the image-recording sheet, the protective layer separable from the substrate may be disposed between the substrate and the transfer layer. In particular, disposing the protective layer dramatically improves resistance (e.g., washing resistance) of the sheet.

As the protective layer, a variety of thermoplastic resins and thermosetting resins, particularly a resin with film-formability (above all, a resin having non-adhesiveness, flexibility and softness) can be employed, as far as the protective layer is separable from the substrate, protects the receptive layer, and dose not extremely deteriorate the quality of a transferred image. Examples of the thermoplastic resin may include a thermoplastic urethane-series resin, a polyamide-series resin, a polyester-series resin, a polycarbonate-series resin, a styrenic resin, a polyolefinic resin, a polyvinyl acetate-series resin, an acrylic resin, and a vinyl chloride-series resin. The thermosetting resin may include, for example, a urethane-series resin, an epoxy-series resin, a phenolic resin, a melamine-series resin, a urea resin, and a silicone-series resin. Among these resins, a urethane-series resin (e.g., the above thermoplastic urethane-series resin) and/or a cationic resin, especially a cationic thermoplastic urethane-series resin is preferred, since such a resin has high wettability with a substrate and can protect the receptive layer efficiently.

As the urethane-series resin, the above-mentioned resins may be used. The preferred thermoplastic urethane-series resin includes, for example, a polyester-based urethane-series resin obtained by using at least a polyester diol as a diol component, especially a polyester-based urethane-series resin obtained by using a diol component containing an aliphatic polyester diol of not less than 50% by weight (e.g., not less than 75% by weight). Moreover, if necessary, a diamine component may be used as the chain-extending agent to change a urethane-series resin into a thermoplastic elastomer. The thermoplastic urethane-series elastomer may include, for example, an elastomer containing an aliphatic polyether or a polyester as a soft segment and a polyurethane unit of a short chain glycol as a hard segment. Examples of the cationic thermoplastic urethane-series resin may include a urethane-series polymer to which the above-mentioned tertiary amino group or the quaternary ammonium salt is introduced.

The thickness of the protective layer is about 0.1 to 20 μm, preferably about 1 to 10 μm (e.g., about 1 to 5 μm), and more preferably about 2 to 7 μm.

[Production Process of Image-Recording Sheet]

The image-recording sheet having a monolayer structure of the present invention may be produced by coating a separable support with a coating agent containing the film-formable resin component comprising the dye fixing agent and the polysaccharide or the derivative thereof (e.g. the cellulose derivative), drying the sheet, and separating thus produced receptive layer from the support. The coating agent may contain, if necessary, the hot-melt adhesive resin particle, depending on the image-forming method or the necessity (or unnecessity) of the transferring. The image-recording sheet having a laminated structure may be formed by coating at least one side of the substrate with the coating agent, and the transferable image-recording sheet may be formed by coating the coating agent on at least one side of the separable substrate. The coating agent may be an oil-based coating agent containing an organic solvent, or may be an aqueous coating agent (e.g., an aqueous solution or an aqueous emulsion). The aqueous coating agent may contain, if necessary, a hydrophilic organic solvent such as an alcohol.

In the transferable image-recording sheet, the protective layer may be formed by coating the release surface of the support with the coating agent for the protective layer, and drying the sheet if necessary, and then, the protective layer may be further coated with the coating agent for the receptive layer.

The coating agent may be applied by a conventional coating method, and the receptive layer may be formed by drying the coated layer at an appropriate temperature, e.g., about 50 to 150° C.

To the receptive layer of the image-recording sheet (or the recording medium), a variety of images is capable of forming (or recording) by attaching or fixing a coloring agent (e.g., an ink composition, a dye and a pigment). That is, the images may be formable (or recordable) on the receptive layer by various recording systems, for example, an ink-jet recording system, a thermal recording system [e.g., a color developing thermal recording system developing a color(s) by heating with use of a color former (or a dye precursor such as leuco dye) and a developer, a sublimation dye transfer (or dye transfer) thermal recording system, a thermofusible transfer thermal recording system transferable a coloring agent composition (or a transfer layer) to the receptive layer by heating and fusing]. Furthermore, an image can be formed by a recording system utilizing a thermal action in a fixing process and others [e.g., an electrophotographic system using a toner].

In particular, the image-recording sheet of the present invention is suitable for the image-forming method utilizing a thermal action on the receptive layer (a thermal image-forming method), since the heating dose not generate a harmful substance from the receptive layer. The present invention also includes a method for forming an image on the receptive layer of the image-recording sheet by an image-forming system utilizing a thermal action. The thermal image-forming method includes, for example, the thermal recording system (e.g., a sublimation dye transfer thermal recording system, a thermofusible transfer thermal recording system, and a color developing thermal recording system), the electrophotographic system, and in addition, an ink-jet recording system in combination with a transfer mechanism (the thermal transfer).

According to the present invention, the use of the image-recording sheet ensures to increase the color quality and the color density, the image with high quality can be formed. Therefore, the present invention also includes an image-forming or image-recording method which comprises allowing the ink composition or the coloring agent (a dye and/or a pigment) to attach to the receptive layer of the image-recording sheet. For example, the present invention is advantageously used for a recording system in which an image is formed on the receptive layer by the ink-jet or sublimation transfer, and is useful as a method for increasing the color density.

Moreover, according to the present invention, the generation of the harmful substance by heating is inhibited, and the working environment and the safety are improved. Therefore, the present invention is useful as a method for preventing or inhibiting the generation of the harmful substance by heating of the image-recording sheet, and is advantageously used for a method for forming an image on the receptive layer of the image-recording sheet by utilizing a thermal action (thermal image-forming method).

The transferable image-recording sheet, for example, is not only useful as a transfer sheet in which an image is recorded on the receptive layer by the ink-jet printing system, but also useful for a method which comprises recording an image on the receptive layer, contacting the transfer layer containing at least the image-recorded receptive layer (e.g., the receptive layer) with the object under heat (after heating, if necessary separating the substrate from the image-recording sheet), and transferring the recorded image together with the transfer layer (e.g., the receptive layer) to the object. More detail, in the system recording an image on the receptive layer of the transferable image-recording sheet (the transfer sheet) by the ink-jet recording system, and transferring the image to an object (the system combining the ink-jet recording system with the transfer mechanism), an image with high color quality and high color density can be recorded by ejecting droplets of ink (in particular an aqueous ink) containing an dye and/or a pigment by the ink-jet recording system. Further, when the transfer method comprises heating the image-recorded receptive layer (or the transfer layer containing this receptive layer) in contact with the object (after heating, the substrate is separated if necessary), and transferring (or forming) the recorded image together with the receptive layer (or the transfer layer) to the object, the use of the present invention for the transfer method ensures inhibiting the generation of the harmful substance (e.g., benzyl chloride), forming the recording image and the transfer image with high color density and clearness, and transferring the image to the object effectively in high thermal transferability and thermal adhesiveness.

Moreover, the image may be formed by recording the image on the receptive layer with the use of various recording systems mentioned above, separating the substrate from the image-recording sheet, contacting the transfer layer (usually, the image-recorded receptive layer) with the object under heat, and then transferring the recorded image together with the transfer layer to the object.

Moreover, in the system recording (or forming) the image on the receptive layer by the sublimation dye transfer mechanism, the image is formed (or recorded) by utilizing sublimation of a dye by heating (the sublimation dye transfer system). In such a system, a coloring agent, which is sublimated by heating a base containing a sublimation coloring agent (e.g., a sublimation dye) by heating means such as a thermal head, is attached to the receptive layer, thereby an image with high color quality can be formed (or recorded) while inhibiting generation of a harmful substance (e.g., benzyl chloride). Incidentally, if necessary, the transfer layer (e.g., the receptive layer) may be heated in contact with the object and the image may be transferred to the object.

In the transferable image-recording sheet whose the receptive layer (or the transfer layer) is transferable to the object, the recorded image formed on the receptive layer can be smoothly transferred or moved to the object by thermocompression bonding the receptive layer (or the transfer layer) in contact with the object at an appropriate temperature (e.g., about 140 to 250° C., and preferably about 140 to 200° C.) with an appropriate pressure (e.g., about 500 to 50,000 Pa) for an appropriate period (e.g., about 5 seconds to 1 minute), and then by separating the transfer layer (the receptive layer or the protective layer) from the substrate. Incidentally, the object having the transferred image may be crosslinked by heating if necessary.

The image-recording sheet of the present invention may greatly lower the content or the generation amount of the harmful substance (e.g., benzyl chloride) than the threshold limit value. The content or the generation amount of benzyl chloride may be, for example, about 0 to 0.1 ppm and preferably about 0 to 0.05 ppm (e.g., about 0 to 0.01 ppm) under the stringent condition. The content or the generation amount is usually not more than the detection limit in preservation at a room temperature or under the usual heating condition.

As the object, there may be utilized two-dimensional or three-dimensional structures made of various materials such as a fiber, a paper, a wood, a plastic, a ceramic and a metal. A cloth, a plastic film or sheet, a paper, or the like may be usually employed as the object. Among these objects, clothing (clothes) such as a T-shirt or fabric is particularly preferred, since the transferable image-forming sheet of the present invention is excellent in texture and washing resistance.

Since the receptive layer contains the polysaccharide or the derivative thereof (e.g., the cellulose derivative) and the aliphatic dye fixing agent, the present invention ensures not only the high color quality or color density but also inhibition of the generation of the harmful substance even by heating. Moreover, the present invention can improve the color density of the image, and ensures a high ink-absorbency and formation of an clear image with inhibiting stain transfer. Further, in the case where the hot-melt adhesive resin particle is contained in the receptive layer, the present invention can prevent the generation of the harmful substance, improve the working environment and the safety even when the image-recording sheet is subjected to the recording system utilizing a thermal action (for example, the thermal recording by sublimation transfer to the receptive layer, or the thermal-transfer recording of the image-formed receptive layer), and therefore, the receptive layer is excellent in thermal transferability and in adhesiveness to the object.

### INDUSTRIAL APPLICABILITY

The image-recording sheet (or the recording medium) of the present invention is useful for forming a variety of images (especially an image with high quality) by various recording systems, for example, the ink-jet recording system, the thermal recording system, the recording system utilizing a thermal action in the fixing mechanism and others (particularly, the recording system utilizing a thermal action, for example, in the case of the ink-jet system, an ink-jet recording system in combination with the transfer mechanism utilizing a thermal action).

Moreover, the present invention can prevent the generation of the harmful substance by heating, improve the working environment and enhance the safety.

Further, the transferable image-recording sheet can be used as, for example, the transfer sheet in which the image is recorded to the receptive layer by the ink-jet recording system. In addition, the transferable image-recording sheet is useful for transferring the recorded image together with the transfer layer (e.g., the receptive layer) to the object, by recording the image on the receptive layer, heating the transfer layer (usually, the receptive layer) containing at least the image-recorded receptive layer in contact with the object, and separating the substrate from the transfer layer (the receptive layer or protective layer).

### EXAMPLES

The following examples are intended to describe the present invention in further detail and should by no means be interpreted as defining the scope of the invention. Incidentally, unless otherwise indicated, “part(s)” indicates the proportion by weight. Moreover, the species or characteristics of each component constituting the receptive layers of the image-forming sheets (the transfer sheets) obtained in Examples and Comparative Examples, and methods for evaluating properties of the image-recording sheets are shown as follows.

(Component Constituting Receptive Layer)

(1) Hot-Melt Adhesive Resin Particle

(i) Resin Particle A1: polyamide 6/12 particle, manufactured by Atofina Japan K.K., “ORGASOL 3501EX D NAT-1”, oil absorption of 212 ml/100 g, melting point of 142° C., mean particle size of 10 μm.

(ii) Resin Particle A2: polyamide 12 particle, manufactured by Daicel-Deggussa Ltd., “VESTAMELT 430-P06”, oil absorption of 45 ml/100 g, melting point of 110° C., mean particle size of 60 μm.

(iii) Resin Particle B: polyamide 12 particle, manufactured by Daicel-Deggussa Ltd., “VESTAMELT 640-P1”, melting point of 76° C., mean particle size of 100 μm.

(2) Polysaccharide or Derivative Thereof

p-1: Cellulose ether, manufactured by Nippon Soda Co., Ltd., hydroxypropyl cellulose “HPC-H”.

p-2: Cellulose ether, manufactured by Daicel Chemical Industries Ltd., hydroxyethyl cellulose “HEC”.

p-3: Starch, manufactured by Oji Corn Starch Co., Ltd., starch “Ace A”.

p-4: Starch ether, manufactured by Nippon Starch Chemical Co., Ltd., carboxymethylated starch “Kiprogum M-800”.

p-5: Starch ester, manufactured by Nippon Starch Chemical Co., Ltd., phosphoric esterified starch “Bribine”.

p-6: Pregelatinized Starch, manufactured by Nippon Starch Chemical Co., Ltd., “Amycol MH-A”.

p-7: Alginic acid salt, manufactured by Sansho Co., Ltd., sodium alginate “Sunarginine MVR”.

p-8: Malto-dextrin, manufactured by Nippon Starch Chemical Co., Ltd., “Amycol No. 6-L”.

p-9: Chitosan, manufactured by KoyoChemical Company Ltd., “SK-2”.

p-10: Pullulan, manufactured by Hayashibara Shoji, Inc. Group Corporation, “PI-20”.

p-11: Gelatin, manufactured by Nitta Gelatin Inc.

(3) Hydrophilic Polymer

Polyethylene glycol: manufactured by Sanyo Chemical Industries, Ltd., “PEG4000S”.

(4) Urethane-Series Resin

Urethane-series resin emulsion: manufactured by Shin-nakamura Chemical Corporation, “SP resin ME-307”.

(5) Acrylic Silicone Resin

In accordance with the Synthesis Example 1 of Japanese Patent Application Laid-Open No. 232936/2001 (JP-2001-232036A), 49 parts by weight of hydroxyethyl methacrylate, 94 parts by weight of diethylaminoethyl methacrylate, 5 parts by weight of trimethoxysilanepropyl methacrylate (Nippon Unicar Company Ltd., “A-174”), 25 parts by weight of acrylic acid, 37 parts by weight of methyl methacrylate, and 37 parts by weight of n-butyl methacrylate were polymerized in isopropanol. After completion of the polymerization, 16 parts by weight of acetic acid was added thereto with stirring, and 705 parts by weight of water was added dropwise to the mixture. Then, isopropanol was distilled off, and an emulsion of an acrylic silicone resin was prepared.

(6) Dye Fixing Agent

(i) Aliphatic Dye Fixing Agent: manufactured by Dai-ichi Kogyo Seiyaku Co., Ltd., “CATIOGEN L”, containing quaternary ammonium salt (trimetylalkylammonium chloride).

(ii) Aromatic Dye Fixing Agent: a 30% by weight aqueous solution of quaternary ammonium salt (benzylalkylammonium chloride).

(Printing Method)

Using an ink jet printer (manufactured by Seiko Epson Corporation, PM-950C), a certain pattern was printed on the each image-recording sheet obtained in Examples and Comparative Examples with inks of cyane, yellow, magenta, black, light cyane, light magenta and dark yellow to form a recording image.

(Transferring Method)

After forming the pattern on the transfer sheet, the image (the printed pattern) was brought into contact with a card white T-shirts (manufactured by Arai Seitaro Shoten K.K., size L). The image-recording sheet was ironed from the backside of the image with loading of 98 N (10 kgf) by an iron (manufactured by Toshiba Corporation, TAD24). The ironing was 4 minutes in total while changing an ironing part every 5 seconds. Furthermore, the ironed transfer sheet and T-shirts were cooled down enough, and then the release paper was separated from them.

(Washing Procedure)

After the transference, the washing operation with a washing machine was carried out by adding 15 g of a neutral detergent to 15 L of warm water of 30° C., washing for 5 minutes, rinsing for 11 minutes and spin-drying for 5 minutes. After repeating this cycle 5 times, the wash was allowed to dry spontaneously.

(Stability of Coating Layer on Delivery of Sheet)

In printing by the ink-jet printer, the defect (or lack) of the coating layer caused by delivery of the sheet was visually observed, and stability of the coating layer on delivery of the sheet was evaluated according to the following criteria.

“A”: the coating layer hardly has the defects or chips

“B”: there is no large change in the appearance of the transfer sheet, however a small amount of a stripped or chipped coating layer component(s) is adhered to the inside of the printer

“C”: the coating layer is chipped, and the transfer sheet is got serious line (or stripe) injures

(Stain Transfer)

After the printing, the image-forming (image-recording) sheet was visually observed if there is any defect with indentation (stain transfer) by the sending roller or not, and the sheet was evaluated based on the following criteria.

“A”: no stain transfer

“B”: a slight stain transfer is found

“C”: terrible stain transfer is found

(Successive or Continuous Delivery of Sheet)

Ten (10) sheets were printed successively or continuously, and the degree of undersupply (e.g., inability to sheet supply or delivery, or clogging of sheet) was evaluated in accordance with the following criteria.

“A”: no undersupply

“B”: two or less pieces of the sheet are not supplied

“C”: the sheet clogs, or three or more sheets are not supplied

(Washing Resistance)

After washing, the transfer image area was observed visually, and the washing resistance was evaluated according to the following criteria.

“A”: there is no change in the transfer image area visually

“B”: the transfer image area slightly fades

“C”: the transfer image area remarkably fades

“D”: the transfer image area is separated from the T-shirts

(Retention of Color Density During Washing)

In each of the image after the transfer (before the washing) and the image after the washing, the reflected color density (a color density) was measured in solid parts of yellow (Y), magenta (M), cyane (C), and black (B). The retention of the color density during washing was calculated from following formula, and the average was determined. Incidentally, the color densities of yellow, Y, magenta, M, cyane, C, and black, B of the transfer image before washing were also shown in Table 1.
Retention of the color density during washing=(the color density after washing)/(the color density before washing)×100 (%)

(Spreadability or Permeation by Soaking)

The printed image and the transferred image were soaked in water at 23° C. for 15 seconds, and pulled up quickly, and then suspended it to allow to dry spontaneously. The degree of the spreadability or permeation was visually observed and evaluated according to the following criteria.

“A”: spreadability or permeation of the ink is hardly occurred

“B”: there is a little spreadability or permeation in yellow

“C”: all colors are spread or permeated, and the fabric discolors

(Red Color Quality)

An image of early-evening landscape was printed on the transfer sheet. The hue of the transferred image was visually observed and evaluated according to the following criteria.

“A”: bright color

“B”: slightly somber color

“C”: terrible somber and blackish development

(Generation and Ambient Concentration of Benzyl Chloride)

The amount of benzyl chloride was measured by a gas chromatography/mass spectrometry method (a GC/MS method) under the following conditions.

Analysis Method:

(1) Preparation of Extract Solution

To prepare an extract solution, the sheet (about 3 g) was immersed in 40 ml of chloroform, treated with ultrasonication at a predetermined temperature (room temperature) for one hour, centrifuged.

(2) GC/MS and Analytic Conditions of GC/MS

Conditions of Py (Thermal Decomposition) Part

Used instrument: Py-2010D (manufactured by Frontier Laboratories Ltd.)

Heating temperature: 180° C.

Heating period: 5 minutes

Ambient gas in heating: synthetic Air (N₂; 80%, O₂; 20%)

Interfacing temperature: 280° C.

Conditions of GC part

Used instrument: GC/MS QP-5050A (GC-17A) (manufactured by Shimadzu Corporation)

Column: DB-624 (manufactured by J&W Scientific) (I.D. 0.53 mm×L 30 m; df. 3.0 μm)

Temperature: Column 80° C. (1 minute)→10° C./minute→160° C. (0 minute)→20° C./minute→220° C. (0 minute)
Injector 280° C.
Interface 280° C.

Head Pressure: 5 kPa

Carrier Gas: He (N60)

Conditions of MS part (SCAN)

Ionization: EI

Ionization Voltage: 70 eV

Sampling Grade: 0.25 second

Monitor Ion: Benzyl chloride m/z=91 (126)

Gain: 1.5 kV

Under the conditions mentioned above, the amount of benzyl chloride contained in the sheet was determined quantitatively. Furthermore, based on the result of the quantitative determination, the expected amount of benzyl chloride generated from 16 pieces of the A4-sized image-recording sheets was calculated, and the concentration of benzyl chloride in a working space (volume: 10 m³) was estimated. Incidentally, the calculation and estimation were carried out assuming the molecular weight of benzyl chloride to be 161.0, and the volume of the gas in standard state to be 22.4 L, respectively.

### Examples 1 to 11 and Comparative Examples 1 to 7

An aqueous coating solution was prepared by mixing the components in Tables 1 and 2 in the proportion shown in Tables 1 and 2 (on solid bases). The aqueous coating solution was coated on a paper for coating (manufactured by Lintec Corporation, BK6RB (S5)) at a coating amount (solid content) of 37 g/m² (in Example 1 and Comparative Examples 1 to 7) and dried at 80° C. to obtain a transfer sheet having a receptive layer. The evaluation results of the obtained transfer sheets are shown in Table 1 and 2. Incidentally, in Examples 2 to 11, the aqueous coating solution was coated at coating amount of about 36 to 38 g/m² (solid content).

TABLE 1

| | | Examples | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Hot-melt adhesive particle | A1 | 17 | 17 | 17 | 17 | 17 | 17 | 17 | 17 | 17 | 17 | 17 |
| | A2 | 64 | 64 | 64 | 64 | 64 | 64 | 64 | 64 | 64 | 64 | 64 |
| | B | 3 | 3 | 3 | 3 | 3 | 3 | 3 | 3 | 3 | 3 | 3 |
| Polysaccharide or the derivative thereof | | p-1 | p-2 | p-3 | p-4 | p-5 | p-6 | p-7 | p-8 | p-9 | p-10 | p-11 |
| | | 2 | 2 | 2 | 2 | 2 | 2 | 2 | 2 | 2 | 2 | 2 |
| Polyethylene glycol PEG | | 4 | 4 | 4 | 4 | 4 | 4 | 4 | 4 | 4 | 4 | 4 |
| Urethane emulsion | | 5 | 5 | 5 | 5 | 5 | 5 | 5 | 5 | 5 | 5 | 5 |
| Acrylic silicone resin | | | | | | | | | | | | |
| Aliphatic dye fixing agent | | 5 | 5 | 5 | 5 | 5 | 5 | 5 | 5 | 5 | 5 | 5 |
| Aromatic dye fixing agent | | | | | | | | | | | | |
| Total (parts by weight) | | 100 | 100 | 100 | 100 | 100 | 100 | 100 | 100 | 100 | 100 | 100 |
| Stability of coating layer on delivery of | | A | A | A | A | A | A | A | A | A | A | A |
| sheet | | | | | | | | | | | | |
| Stain transfer | | A | A | A | A | A | A | A | A | A | A | A |
| Successive or continuous delivery of sheet | | A | A | A | A | A | A | A | A | A | A | A |
| Washing resistance | | A | A | A | A | A | A | A | A | A | A | A |
| Retention of color density during washing | | 88 | 88 | 87 | 88 | 88 | 87 | 88 | 86 | 88 | 87 | 88 |
| (%) | | | | | | | | | | | | |
| Color density before washing | Y | 1.0 | 1.0 | 1.0 | 1.0 | 1.0 | 1.0 | 1.0 | 1.0 | 1.0 | 1.0 | 1.0 |
| | M | 1.2 | 1.2 | 1.2 | 1.2 | 1.2 | 1.2 | 1.2 | 1.2 | 1.2 | 1.2 | 1.2 |
| | C | 1.1 | 1.1 | 1.1 | 1.1 | 1.1 | 1.1 | 1.1 | 1.1 | 1.1 | 1.1 | 1.1 |
| | B | 1.5 | 1.5 | 1.5 | 1.5 | 1.5 | 1.5 | 1.5 | 1.5 | 1.5 | 1.5 | 1.5 |

| | | | | | | | | | | | |
|---|---|---|---|---|---|---|---|---|---|---|---|
| Spreadability or permeation by soaking | A | A | A | A | A | A | A | A | A | A | A |
| Red color quality | A | A | A | A | A | A | A | A | A | A | A |
| Amount of benzyl chloride (μg/g) | 5 | 5 | 4 | 5 | 5 | 4 | 5 | 6 | 5 | 6 | 5 |
| Concentration in working environment (ppm) | 0.01 | 0.01 | 0.01 | 0.01 | 0.01 | 0.01 | 0.01 | 0.01 | 0.01 | 0.01 | 0.01 |

TABLE 2

| | | Comparative Examples | | | | | | |
|---|---|---|---|---|---|---|---|---|
| | | 1 | 2 | 3 | 4 | 5 | 6 | 7 |
| Hot-melt adhesive particle | A1 | 20 | 20 | 17 | 9.4 | 18.4 | 9.4 | 17 |
| | A2 | 40 | 50 | 68 | 44.1 | 18.4 | 44.1 | 64 |
| | B | | | | 1.7 | 18.4 | 1.7 | 3 |
| Polysaccharide or the derivative thereof | | | | | | | | |
| Polyethylene glycol PEG | | | | 5 | 15.4 | 15.4 | 15.4 | 6 |
| Urethane emulsion | | 35 | | 5 | 20.9 | 20.9 | 20.9 | 5 |
| Acrylic silicone resin | | | 25 | | | | | |
| Aliphatic dye fixing agent | | 5 | 5 | | | | 8.5 | 5 |
| Aromatic dye fixing agent | | | | 5 | 8.5 | 8.5 | | |
| Total (parts by weight) | | 100 | 100 | 100 | 100 | 100 | 100 | 100 |
| Stability of coating layer on delivery of | | B | B | A | A | A | A | A |
| sheet | | | | | | | | |
| Stain transfer | | A | A | A | A | A | A | A |
| Successive or continuous delivery of sheet | | B | B | A | A | B | A | A |
| Washing resistance | | A | A | A | A | B | A | A |
| Retention of color density during washing (%) | | 88 | 88 | 77 | 91 | 80 | 78 | 88 |
| Color density before washing | Y | 0.9 | 0.9 | 0.9 | 0.9 | 0.9 | 0.9 | 0.9 |
| | M | 1.0 | 1.0 | 1.0 | 1.0 | 1.0 | 1.0 | 1.0 |
| | C | 1.0 | 0.9 | 1.0 | 1.0 | 0.9 | 1.0 | 1.0 |
| | B | 1.3 | 1.3 | 1.3 | 1.4 | 1.4 | 1.3 | 1.4 |

| | | | | | | | |
|---|---|---|---|---|---|---|---|
| Spreadability or permeation by soaking | A | A | A | A | A | A | A |
| Red color quality | B | B | A | A | B | A | A |
| Amount of benzyl chloride (μg/g) | 4 | 5 | 380 | 560 | 520 | 4 | 5 |
| Concentration in working environment (ppm) | 0.01 | 0.01 | 0.63 | 0.93 | 0.87 | 0.01 | 0.01 |

As apparent from the Tables 1 and 2, the transfer sheets of the Examples can greatly inhibit the generation of benzyl chloride and improve the working environment as well as the safety. Moreover, these sheets can enhance the color density and form a clear image. Further, even when the hot-melt adhesive resin particle is contained in the receptive layer, the transfer sheets of Examples can form high-quality transfer images without deterioration of characteristic of the printer.

1. An image-recording sheet comprising a receptive layer on which an image is formable, wherein the receptive layer contains
a film-formable resin component comprising a polysaccharide or a derivative thereof, and
a dye fixing agent comprising an aliphatic dye fixing agent.

2. An image-recording sheet according to claim 1, which comprises a substrate and a transfer layer, wherein the transfer layer is formed on and separable from the substrate and contains at least the receptive layer;
wherein the receptive layer further contains a hot-melt adhesive resin particle, and the transfer layer is transferable to an object.

3. An image-recording sheet according to claim 1, wherein the polysaccharide or the derivative thereof comprises a cellulose derivative.

4. An image-recording sheet according to claim 3, wherein the cellulose derivative comprises a cellulose ether or a cellulose ester.

5. An image-recording sheet according to claim 1, wherein the dye fixing agent comprises an aliphatic quaternary ammonium salt.

6. An image-recording sheet according to claim 1, wherein the dye fixing agent comprises an aliphatic quaternary ammonium salt having at least one long chain alkyl group.

7. An image-recording sheet according to claim 1, wherein the dye fixing agent comprises at least one member selected from the group consisting of a tetraC₁₋₆alkylammonium halide, a triC₁₋₄alkylC₈₋₂₀alkylammonium halide, and a diC₁₋₄alkyldiC₈₋₂₀alkylammonium halide.

8. An image-recording sheet according to claim 1, wherein the ratio (weight ratio) of the polysaccharide or the derivative thereof relative to the aliphatic dye fixing agent [the former/the latter] is 10/90 to 70/30.

9. An image-recording sheet according to claim 1, wherein the film-formable resin component comprises the polysaccharide or the derivative thereof and a hydrophilic polymer in a proportion (weight ratio) of 10/90 to 90/10 as the former/the latter.

10. An image-recording sheet according to claim 1, wherein the film-formable resin component comprises a combination of a hydroxyalkyl cellulose and an oxyalkylene-series polymer having an oxyethylene unit.

11. An image-recording sheet according to claim 1, wherein the film-formable resin component comprises the polysaccharide or the derivative thereof and a urethane-series resin in a proportion (weight ratio) of 5/95 to 90/10 as the former/the latter.

12. An image-recording sheet according to claim 1, wherein the film-formable resin component comprises the polysaccharide or the derivative thereof, a hydrophilic polymer and a urethane-series resin, and the ratio (weight ratio) of the total amount of the polysaccharide or the derivative thereof and the hydrophilic polymer relative to the urethane-series resin [the former/the latter] is 10/90 to 90/10.

13. An image-recording sheet according to claim 2, wherein the hot-melt adhesive resin particle comprises an aliphatic polyamide-series resin.

14. An image-recording sheet according to claim 2, wherein the hot-melt adhesive resin particle comprises a porous resin particle and a non-porous resin particle.

15. An image-recording sheet according to claim 2, wherein the proportion of the hot-melt adhesive resin particle is, on solid bases, 10 to 10000 parts by weight relative to 100 parts by weight of the film-formable resin component;
the hot-melt adhesive resin particle contains (A) a hot-melt adhesive resin particle with a melting point of higher than 80° C. and (B) a hot-melt adhesive resin particle with a melting point of not higher than 80° C.; and
the hot-melt adhesive resin particle (A) comprises (A1) a hot-melt adhesive resin particle with an oil absorption of not less than 50 ml/100 g and (A2) a hot-melt adhesive resin particle with an oil absorption of less than 50 ml/100 g.

16. A process for forming an image on a receptive layer of an image-recording sheet recited in claim 1, which comprises forming an image by a thermally image-forming system.

17. A process according to claim 16, which comprises
recording an image on a receptive layer of an image-recording sheet recited in claim 2,
contacting a transfer layer containing at least the image-recorded receptive layer with an object under heat, and
transferring the recorded image together with the transfer layer to the object.
